(19) United States
(12) Patent Application Publication
(10) Pub. No.: US 2020/0340612 A1
(43) Pub. Date: Oct. 29, 2020

(54) THERMAL INSULATION SHEET AND MULTILAYER THERMAL INSULATION SHEET USING SAME

(71) Applicant: Panasonic Intellectual Property Management Co., Ltd., Osaka (JP)

(72) Inventors: NORIHIRO KAWAMURA, Hokkaido (JP); CHIHIRO SATOU, Hokkaido (JP); RYOSUKE USUI, Hokkaido (JP)

(21) Appl. No.: 16/610,081

(22) PCT Filed: May 30, 2018
(86) PCT No.: PCT/JP2018/020692

§ 371 Date: Nov. 1, 2019

(30) Foreign Application Priority Data
Jun. 16, 2017 (JP) 2017-118305

(51) Int. Cl. F16L 59/02; F16L 59/10; B32B 27/36; B32B 27/32; B32B 27/12; B32B 5/02; B32B 3/26; B32B 7/12

(52) U.S. Cl. CPC F16L 59/029; F16L 59/10; B32B 27/36; B32B 27/32; B32B 2255/02; B32B 5/022; B32B 3/266; B32B 7/12; B32B 2307/304; B32B 27/12

(57) ABSTRACT

The present disclosure is intended to provide a thermal insulation sheet that is resistant to being damaged even if enlarged in shape, as well as a multilayer thermal insulation sheet including such a thermal insulation sheet. The thermal insulation sheet includes a thermal insulator made of a nonwoven fabric that supports a xerogel in internal spaces. The thermal insulator has a plurality of through holes in an internal region in a plan view. Protective sheets are disposed on two respective surfaces of the thermal insulator. The protective sheets are joined together at a periphery of the thermal insulator and through inside the through holes.

### TECHNICAL FIELD

The present disclosure relates to a thermal insulation sheet used to provide thermal insulation and to a multilayer thermal insulation sheet including the thermal insulation sheet.

### BACKGROUND ART

In recent years, energy conservation has been widely required. A method for achieving energy conservation is to improve energy efficiency by controlling temperature of equipment. Controlling equipment temperature requires a thermal insulation sheet that produces excellent thermal insulation effect. Hence, a thermal insulation sheet that is occasionally used is made of a nonwoven fabric that supports silica xerogel inside to have a lower coefficient of thermal conductivity than air does.

PTL 1 is, for example, known as a traditional art document containing information related to the invention in this application.

### CITATION LIST

### Patent Literature

PTL 1: Unexamined Japanese Patent Publication No. 2011-136859

### SUMMARY OF THE INVENTION

Unfortunately, the thermal insulation sheet described above is poor in adhesiveness and requires a protective sheet because the silica xerogel readily comes off. The thermal insulation sheet, if enlarged in shape, is readily damaged by external force unless the protective sheet is fastened.

An object of the present disclosure, accomplished to solve the problem, is to provide a thermal insulation sheet that is resistant to being damaged even if enlarged in shape. Another object of the present disclosure is to provide a method of producing such a thermal insulation sheet.

A thermal insulation sheet according to the present disclosure, accomplished to solve the problem described above, includes a thermal insulator including a nonwoven fabric that supports a xerogel in internal spaces. The thermal insulator has a plurality of through holes in an internal region in a plan view. A first protective sheet is disposed on one of two surfaces of the thermal insulator, and a second protective sheet is disposed on the other surface of the thermal insulator. The first protective sheet and the second protective sheet are joined together at a periphery of the thermal insulator and through inside the through holes.

In a thermal insulation sheet that is configured as described above, protective sheets are joined together at a periphery of a thermal insulator and through inside through holes. This configuration enables the thermal insulation sheet to be resistant to being damaged even if enlarged in shape.

### BRIEF DESCRIPTION OF DRAWINGS

FIG. 1 is an exploded perspective view of a thermal insulation sheet according to an exemplary embodiment of the present disclosure.

FIG. 2 is a cross-sectional view of the thermal insulation sheet according to the exemplary embodiment of the present disclosure.

FIG. 3 is a cross-sectional view of another thermal insulation sheet according to the exemplary embodiment of the present disclosure.

FIG. 4 is a cross-sectional view of still another thermal insulation sheet according to the exemplary embodiment of the present disclosure.

FIG. 5 is a cross-sectional view of a multilayer thermal insulation sheet according to the exemplary embodiment of the present disclosure.

FIG. 6 is a cross-sectional view of another multilayer thermal insulation sheet according to the exemplary embodiment of the present disclosure.

### DESCRIPTION OF EMBODIMENT

A thermal insulation sheet according to an exemplary embodiment of the present disclosure will now be described with reference to the drawings.

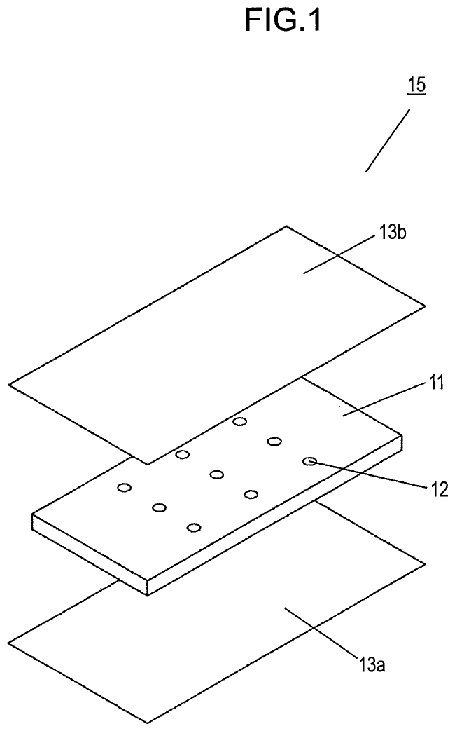

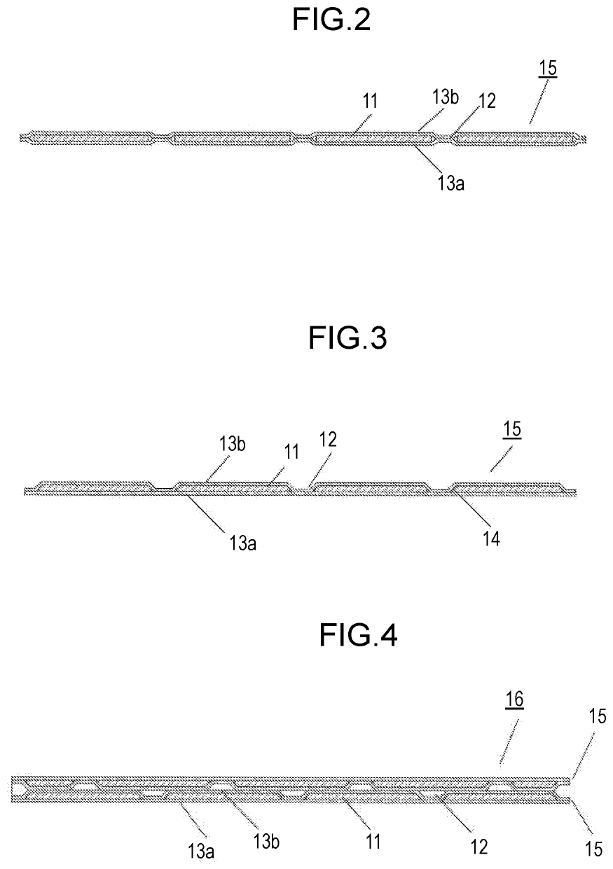

FIG. 1 and FIG. 2 are an exploded perspective view and a cross-sectional view, respectively, of thermal insulation sheet 15 according to the exemplary embodiment of the present disclosure.

Thermal insulator 11 includes a nonwoven fabric made of polyethylene terephthalate (hereinafter referred to as PET) having internal spaces in which silica xerogel is supported. The silica xerogel has nanometer-scale voids that impede movement of air molecules. Thermal insulator 11 has a coefficient of thermal conductivity ranging from 0.018 W/m·K to 0.024 W/m·K. The silica xerogel is, in a broad sense, a xerogel formed from a gel by drying. The silica xerogel may be produced by normal drying or other methods such as supercritical drying or freeze-drying.

Thermal insulator 11 has a thickness of approximately 0.5 mm and is about 100 mm square in size. In an internal region of thermal insulator 11, a plurality of through holes 12 is disposed at intervals of approximately 25 mm in a plan view. Through holes 12 each have a diameter of about 2 mm.

First protective sheet 13a made of PET with a thickness of approximately 0.01 mm is disposed on one of two surfaces of thermal insulator 11. Second protective sheet 13a is disposed on the other surface of the thermal insulator. First protective sheet 13a and second protective sheet 13b are larger in shape than thermal insulator 11. First and second protective sheets 13a and 13b are joined together at an entire periphery of thermal insulator 11. Further, first and second protective sheets 13a and 13b are joined together through inside through holes 12. Owing to this configuration, thermal insulator 11 is sealed by first and second protective sheets 13a and 13b. A surface of first protective sheet 13a facing thermal insulator 11 and a surface of second protective sheet 13b facing thermal insulator 11 are provided with respective acrylic adhesive layers. Protective sheets 13 are joined together by these adhesive layers. First and second protective sheets 13a and 13b may be made of a thermoplastic resin and be joined together by heat sealing.

First protective sheet 13a and second protective sheet 13b are hereinafter collectively referred to as protective sheets 13.

Since thermal insulator 11 includes silica xerogel supported in the internal spaces of the nonwoven fabric, thermal insulator 11 and protective sheets 13 (first and second protective sheets 13a and 13b) can scarcely join together even though the protective sheets are provided with the adhesive layers. As a result, the protective sheets float over the surfaces of the thermal insulator. This does not cause any problem in particular if the thermal insulator is small in size. However, if the thermal insulator is enlarged in shape, the protective sheets provide decreased strength in response to the application of an external force. In contrast, in this exemplary embodiment, protective sheets 13 are joined together through inside through holes 12 as well and hence this configuration prevents the strength of the thermal insulator from decreasing even if thermal insulator 11 is enlarged in shape.

Preferably, through holes 12 are large enough to ensure that protective sheets 13 are joined together through inside through holes 12. However, an increase in the size of through holes 12 decreases thermal insulation performance. Thus, as shown in FIG. 3, it is preferred that a part of thermal insulator 11 around through hole 12 get thinner in thickness with a decrease in distance to a center of through hole 12. In this way, the thermal insulator includes tapered face 14 around each through hole 12 so that protective sheets 13 are readily joined together through inside through holes 12. Tapered faces 14 may be formed on the two surfaces of the thermal insulator. It is, however, preferred that as shown in FIG. 3 tapered face 14 on one of the surfaces be larger than tapered face 14 on the other surface. In this configuration, first and second protective sheets 13a and 13b may be made of respective materials that differ from each other, such as PET for lower first protective sheet 13a and polyethylene for upper second protective sheet 13b. The polyethylene sheet is higher in ductility than the PET sheet. Thus, protective sheet 13 with higher ductility may be used for the surface adjacent to the larger tapered faces to further facilitate joining of protective sheets 13 together through inside through holes 12.

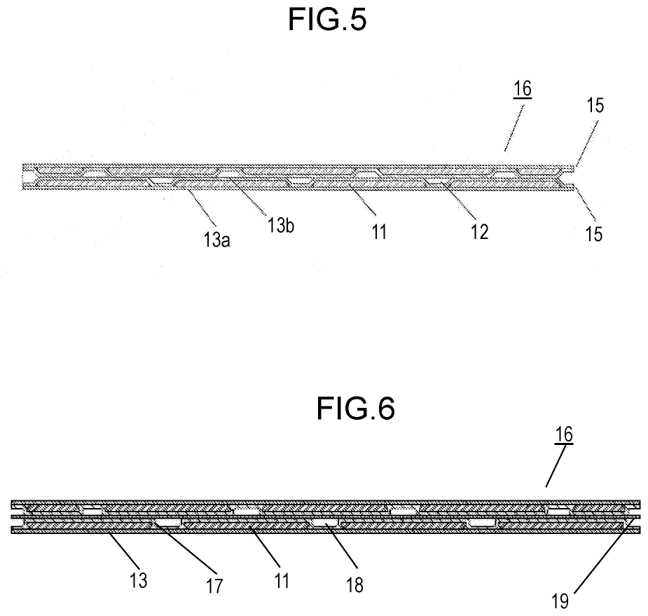

FIG. 5 is a cross-sectional view of multilayer thermal insulation sheet 16 according to the exemplary embodiment of the present disclosure. A thermal insulation sheet made of an identical material improves in thermal insulation performance with an increase in thickness. Hence, the thermal insulation sheet needs to be thickened to improve the thermal insulation performance. However, a thermal insulator of FIG. 1 that is thickened poses a problem in sealing performance. Consequently, it is preferred that a plurality of such thermal insulation sheets 15 be stacked together to form multilayer thermal insulation sheet 16. A single piece of thermal insulation sheet 15 as shown in FIG. 1 is apt to provide decreased thermal insulation performance near each through hole 12. Hence, if a plurality of the sheets is stacked together, it is preferred that through holes 12 of adjacent thermal insulation sheets 15 do not overlap each other. In this configuration, an external surface of protective sheet 13 of each thermal insulation sheet 15 may be provided with an adhesive layer so that thermal insulation sheets 15 are stuck together by these adhesive layers. Alternatively, thermal insulation sheets 15 may be stuck together by double-sided tape. A configuration like this keeps thermal insulation sheets 15 from slipping along each other and prevents a decrease in thermal insulation performance. Further, outer most thermal insulation sheet 15 of multilayer thermal insulation sheet 16 is preferably stacked such that larger tapered face 14 of thermal insulator 11 around each through hole 12 is disposed inward. This configuration confines air inside a space of through hole 12 and hence provides improved thermal insulation performance.

As shown in FIG. 4, thermal insulation sheet 15 may include thermal insulator 11 having a plurality of through holes 12, protective sheet 13, and a coating film (not shown in FIG. 4) with a thickness of about 10 μm such that thermal insulator 11 is entirely covered with protective sheet 13 stacked on one of two surfaces of the thermal insulator and the coating film formed on the other surface of the thermal insulator. In this configuration, through hole 12 preferably has tapered face 14 having a reversed taper such that through hole 12 is larger in area at a first edge facing protective sheet 13 than at a second edge remote from protective sheet 13. The through holes formed in this way provide an increased area of contact between protective sheet 13 and the coating film, resulting in improved bonding strength.

As shown in FIG. 6, a plurality of thermal insulation sheets 15 of FIG. 4 may be stacked and stuck together to form multilayer thermal insulation sheet 16. In this configuration, coating film 17 preferably has recess 18 near a center of each through hole 12. Preferably, the thermal insulation sheets are stuck together by double-sided tape 19 such that surfaces of the sheets provided with recesses 18 are placed face-to-face. This configuration confines air inside recesses 18 and hence provides improved thermal insulation performance.

Next, a method of producing the thermal insulation sheet according to the exemplary embodiment of the present disclosure will be described.

First, a nonwoven fabric made of PET with a thickness of approximately 0.5 mm is prepared.

The nonwoven fabric is, for example, immersed in a colloidal solution that is formed from a sodium silicate solution doped with hydrochloric acid to impregnate internal spaces of the nonwoven fabric with the colloidal solution. The colloidal solution is gelatinized, dehydrated, and dried to fill the internal spaces of the nonwoven fabric with silica xerogel. As a result, thermal insulator 11 is acquired. In an internal region of thermal insulator 11, a plurality of through holes 12 with a diameter of about 2 mm is formed at intervals of approximately 25 mm by die cutting. Protective sheets 13 that are larger in shape than thermal insulator 11 are stacked on respective two surfaces of thermal insulator 11. Protective sheets 13 are joined together at a periphery of thermal insulator 11 and through inside through holes 12. As a result, thermal insulation sheet 15 is acquired. In this configuration, it is preferred that at least one surface of each protective sheet 13 be provided with an adhesive layer so that protective sheets 13 are joined together by these adhesive layers.

In this case, it is preferred that a part of thermal insulator 11 around through hole 12 get thinner in thickness with a decrease in distance to a center of through hole 12. In this way, thermal insulator 11 includes tapered face 14 around each through hole 12 so that protective sheets 13 are readily joined together through inside through holes 12. If the die has a tapered face around a portion for forming the through hole, tapered face 14 can be formed on the through hole concurrently with die cutting. This contributes to streamlining the manufacturing process.

Thermal insulator 11 may be acquired by forming through holes 12 and tapered faces 14 in a nonwoven fabric by die cutting and then filling internal spaces of the nonwoven fabric with silica xerogel.

### INDUSTRIAL APPLICABILITY

A thermal insulation sheet according to the present invention and a multilayer thermal insulation sheet including the same are resistant to being damaged even if enlarged in shape, and hence are useful for industrial applications.

### REFERENCE MARKS IN THE DRAWINGS

11 thermal insulator
12 through hole
13 protective sheet
13a first protective sheet
13b second protective sheet
14 tapered face
15 thermal insulation sheet
16 multilayer thermal insulation sheet
17 coating film
18 recess
19 double-sided tape

1. A thermal insulation sheet comprising a thermal insulator including a nonwoven fabric that supports a xerogel in internal spaces of the nonwoven fabric,
wherein the thermal insulator has a plurality of through holes in an internal region in a plan view,
wherein a first protective sheet is disposed on one of two surfaces of the thermal insulator, and a second protective sheet is disposed on another surface of the thermal insulator, and
wherein the first protective sheet and the second protective sheet are joined together at a periphery of the thermal insulator and through inside the through holes.

2. The thermal insulation sheet according to claim 1, wherein the first protective sheet and the second protective sheet are comprised of respective materials that differ from each other.

3. The thermal insulation sheet according to claim 1, wherein a part of the thermal insulator around each of the through holes gets thinner in thickness with a decrease in distance to a center of each of the through holes.

4. A thermal insulation sheet comprising a thermal insulator including a nonwoven fabric that supports a xerogel in internal spaces,
wherein the thermal insulator has a plurality of through holes in an internal region in a plan view,
wherein a protective sheet is disposed on one of two surfaces of the thermal insulator, and a coating layer is disposed on another surface of the thermal insulator, and
wherein the protective sheet and the coating layer are joined together at a periphery of the thermal insulator and through inside the through holes.

5. The thermal insulation sheet according to claim 4,
wherein the through holes each have a taper shape in such a way that each of the through holes is larger in area at a cross-sectional edge facing the protective sheet than at a cross-sectional edge adjacent to the coating layer, and
wherein the coating layer has a recess near a center of each of the through holes.

6. A multilayer thermal insulation sheet comprising a plurality of the thermal insulation sheets according to claim 1 in a stack, wherein the through holes of one of adjacent thermal insulation sheets adjacent to each other among the plurality of thermal insulation sheets do not overlap the through holes of another thermal insulation sheet of the adjacent thermal insulation sheets.

7. The multilayer thermal insulation sheet according to claim 6, wherein the adjacent thermal insulation sheets are stuck together by an adhesive material.
